(19) United States
(12) Patent Application Publication
(10) Pub. No.: US 2009/0052313 A1
(43) Pub. Date: Feb. 26, 2009

(54) MANUFACTURING RECORD CARRIERS SUITABLE FOR POST-RECORDING

(75) Inventor: Peter Bentvelsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,413

(22) PCT Filed: Nov. 4, 2005
(86) PCT No.: PCT/IB05/53608

§ 371 Date: May 2, 2007

(30) Foreign Application Priority Data
Nov. 9, 2004 (EP) 04105641.7

(51) Int. Cl. G11B 7/26

(52) U.S. Cl. 369/275.4; G9B/7.194

(57) ABSTRACT

The present invention relates to a method and to an apparatus for manufacturing a record carrier having stored a content information in the form of a modulated bitstream 29 obtained from the content information by steps of encoding 21 and modulating 26. The record carrier has a number of dummy patterns at predetermined locations, allowing for the post-recording of secondary information, e.g. an individual code, whereby the secondary information is recorded by selectively modifying the dummy patterns. The method and apparatus according to the invention foresee that the modulated bitstream 29 with dummy patterns at the predetermined positions id obtained by inserting data word corresponding to the dummy patterns in a sequence of data words before the modulation takes place, so as to make sure that the dummy patterns are compliant with the modulation employed.

The present invention relates to a method and to an apparatus for manufacturing a record carrier having stored a content information, allowing for the post-recording of secondary information.

It is known that ROM optical discs are obtained by a molding process, whereby a plurality of discs having exact replicas of the same content information, or user data, is obtained, the content information being e.g. music, a movie, software, which is often a copy-protected material. For some application it would be desirable that the individual discs would differ at least in some part of the carried information. However this cannot be achieved by said molding process. A straightforward application could be, for example, the possibility to distinguish individual discs as a basis for an authentication, access control, or copy protection scheme, particularly in the context of super distribution.

In WO 02/101733 a so-called post-recording method is described which makes it possible to record a secondary information, such as a Unique Disc ID, onto a read-only optical record carrier after disc production. The method, also called “Postscribed ID” (PID), is also used by Sony for CD-ROM. In PID, lands between the stamped pits can be converted, so as to give a pit-like reflection, using laser ablation. The thin film reflective layer (that usually consists of aluminum for conventional discs) has a special composition to allow ablation of the layer. After ablation, the local reflectance will be low and comparable to a stamped pit. Recording in a pit will not lead to a significant reflectivity change, thus, overwritten pit sections remain ‘pit’ whereas overwritten ‘land’ sections are transformed into ‘pit’ for the read-out process. Using this method it is thus possible to adapt the modulation stream, therefore, a plurality of CD-ROM having the same user-information can be obtained in a first step by a molding process; in a second step, the individual members of the plurality can be differentiated by adding an individual Postscribed ID (a Unique Disc ID; in general, a secondary information) to each disc. In order not to corrupt the content information, a special area of the disc is provided where dummy patterns, not relevant for the user and not part of the content information, are pre-recorded: the secondary information is added here.

It is an object of the present invention to provide a method and an apparatus for manufacturing a record carrier having at predetermined positions patterns of a desired type for being modified by a post-recording process for recording of secondary information, which secondary information can be retrieved in a relatively simple way.

This object is achieved according to the invention by a method as claimed in claim 1 and by an apparatus as claimed in claim 4. Preferred embodiments of the invention are claimed in the dependent claims.

It has to be noted that the secondary information is recorded in the same information channel where the content information is pre-recorded, and thus needs to be retrieved by use of substantially the same demodulation/decoding circuitry.

It also has to be noted that the content information is present in the information carrier in the form of a modulated bitstream obtained from the content information by encoding the content information and modulating the encoded content information.

Encoding the content information comprises a combination of:
an error correction code (ECC) generation, by which the data words representing the content information are enhanced with ECC,
shuffling the data words and/or interleaving them with other data words, and
scrambling the data words.

Modulating the encoded content information foresees converting each data word into a channel word, representable as a pattern of 1s and 0s, or, in case of an optical record carrier, pits and lands.

The invention is primarily based on the recognition that both in providing an area for being modified in a post-recording process, as well as in having this area modified in the post-recording process, it is potentially introduced on the record carrier some pattern which is not compliant with modulation rules that are foreseen.

The reasons for the presence of a modulation step can be to introduce some redundancy which allows to detect/correct errors while retrieving the recorded content information, and/or to render the information to be recorded in a form which is compatible with the bandwidth constraints imposed by a particular recording system, like for example in Optical Storage where a Run-Lenght Limited (RLL) encoding is used.

In Optical recording systems like for example according to the CD, DVD or BD standards, in particular, the modulation step comprises a step of associating to a data word of n bits a channel word of m bits, with m>n. As a consequence, in the space of channel words, i.e. all the 2^{m} channel words obtainable with m bits, only some are foreseen by the relevant modulation algorithm (EFM for CD, EFM+ for DVD and 17PP for BD), whereas the other are non-valid channel words. In contrast, the channel words to which a data word can be associated are herein referred to as valid channel words. In a reproduction apparatus the detection of a non-valid channel word gives rise to marking that channel word as erroneous during demodulation. Therefore, the dummy patterns predisposed for being modified in a post-recording process, need to be compliant with the modulation rules employed, i.e. they need to be valid patterns, or corresponding to valid channel words, otherwise, as non-valid patterns, they would oblige to an adaptation of the demodulation. Moreover, as non-valid patterns, the dummy patterns could violate the RLL (read: bandwidth) constraints of the channel, putting even more burden on the analog pre-processing of the High Frequency signal retrieved from the record carrier and on the demodulation in general in order to correctly detect these patterns.

Instead, if the dummy patterns are valid patterns, no modifications at demodulation level and analog pre-processing are necessary at all; the upper layer—the decoding level—instead, has to be adapted, because it has to know where the dummy patterns are supposed to be, and how they are supposed to look like, with or without modification. During decoding there must not be an attempt to correct the patterns that have been modified in the post-recording process. However this adaptation is a relatively simple one. In practice, the dummy patterns are placed at predetermined locations; a unit in a decoder will check one by one if the patterns present at the predetermined locations have been modified or not, thereby retrieving the secondary information which has been recorded.

Thus, in order to allow the recording, or “post-recording” as is sometimes referred, of a secondary information, which can be individual to each record carrier, such as a Unique Disc ID, a record carrier has to be provided which has dummy patterns, which correspond to valid channel words, at predetermined location. The secondary information can then be stored on the record carrier by selectively modifying said dummy patterns in said post-recording process.

It is clarified that, in the context of this document, the expressions “dummy pattern” and “dummy channel word” are not used to refer a pattern or a channel word of no value at all, but rather a pattern or a channel word which is not carrying any content information. I.e., the dummy pattern or dummy channel word are indeed irrelevant, or “dummy”, from the point of view of the content information, nevertheless the are relevant to the secondary information, since a dummy pattern or channel word, whether modified or not stores a piece of said secondary information. The distinction between pattern and channel word is clarified hereinafter.

In the case of a ROM record carrier, i.e. a, record carrier where the content information is pre-recorded and is not modifiable by the user, the dummy patterns and the patterns encoding the content information are preferably formed by means of a unique step, for example a molding process. Therefore it is possible to create a plurality of record carriers having prerecorded the same content information, where differentiated secondary information can then be recorded. However the invention can also be applied to record carriers recordable by the user, where the method according to the invention can be used to pre-record an individual code on the record carrier, which can be useful according to some models of distribution of copy-protected content.

The present invention is thus based on the further recognition that it is not possible to generate a modulated bitstream having desired patterns at predetermined positions by simply modifying the pattern present in a modulated bitstream at the predetermined positions, because this would, in general, cause a violation of the modulation rules (i.e. the RLL constraints). Instead, according to the invention a modulated bitstream having desired patterns at predetermined positions is obtained by inserting data words corresponding to the desired patterns in the succession of data words, before the modulation takes place.

The invention will now be explained in more detail with reference to the drawings in which:

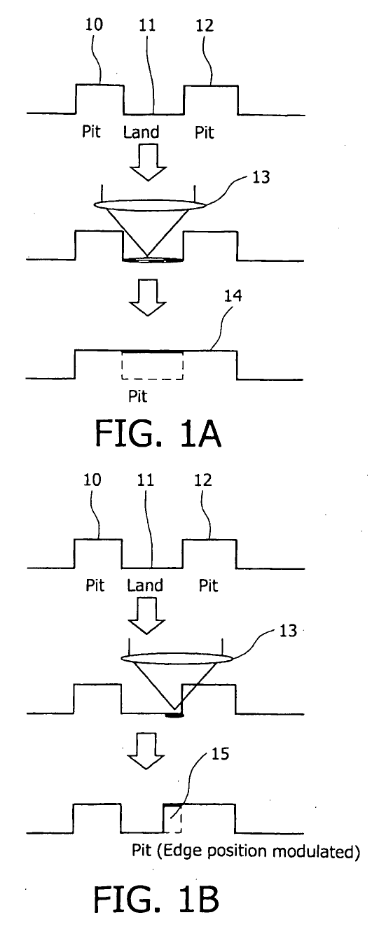

FIG. 1 illustrates the basic principle of the known post-recording method,

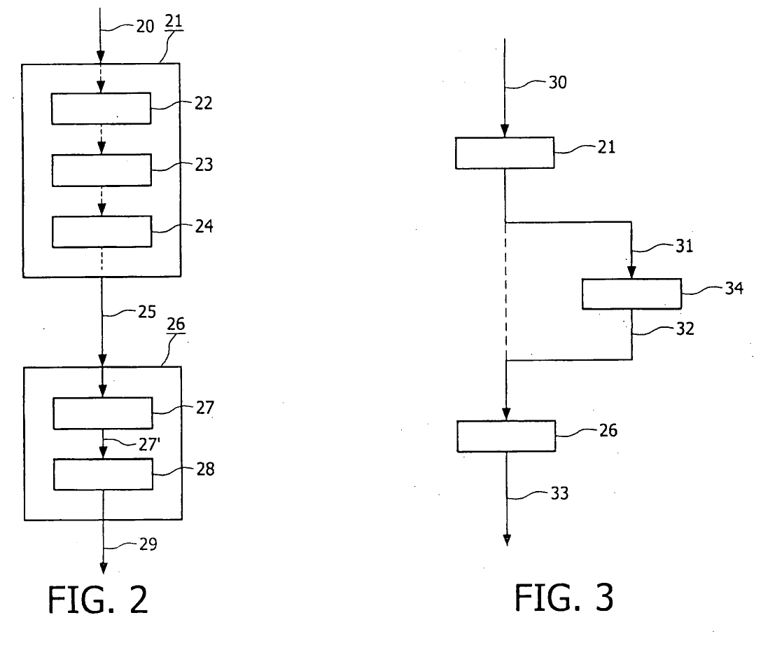

FIG. 2 shows a schematic diagram of a known method for encoding content information,

FIG. 3 shows a schematic diagram of a method of manufacturing a record carrier according to the invention,

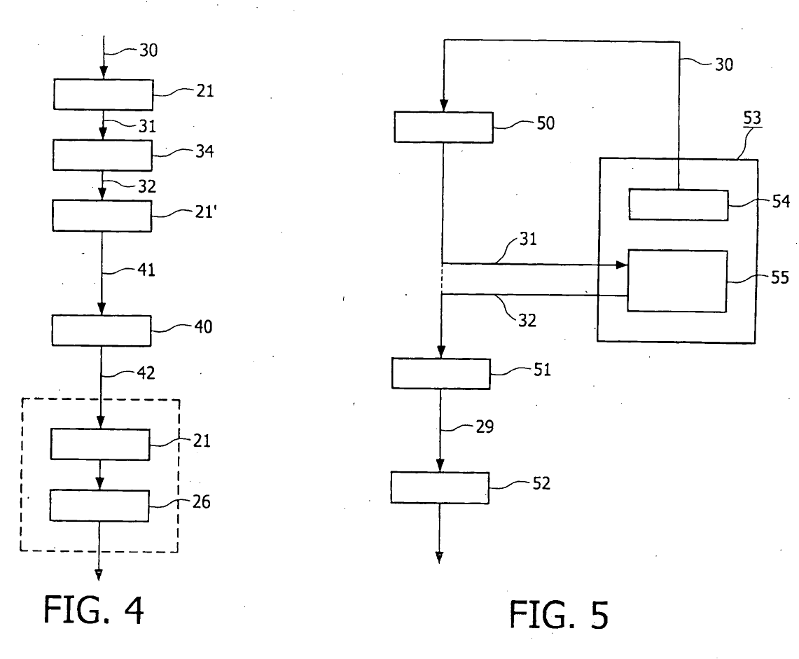

FIG. 4 shows an embodiment of the method of manufacturing a record carrier according to the invention,

FIG. 5 shows a schematic diagram of an apparatus for manufacturing a record carrier according to the invention,

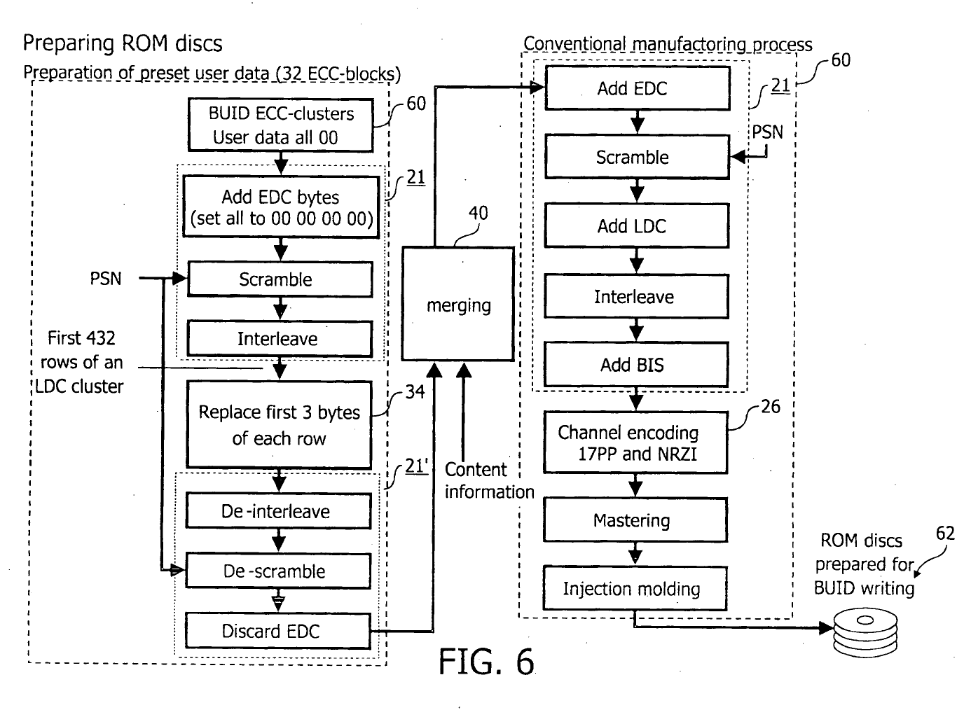

FIG. 6 shows a further embodiment of the method for manufacturing a record carrier according to the invention, and

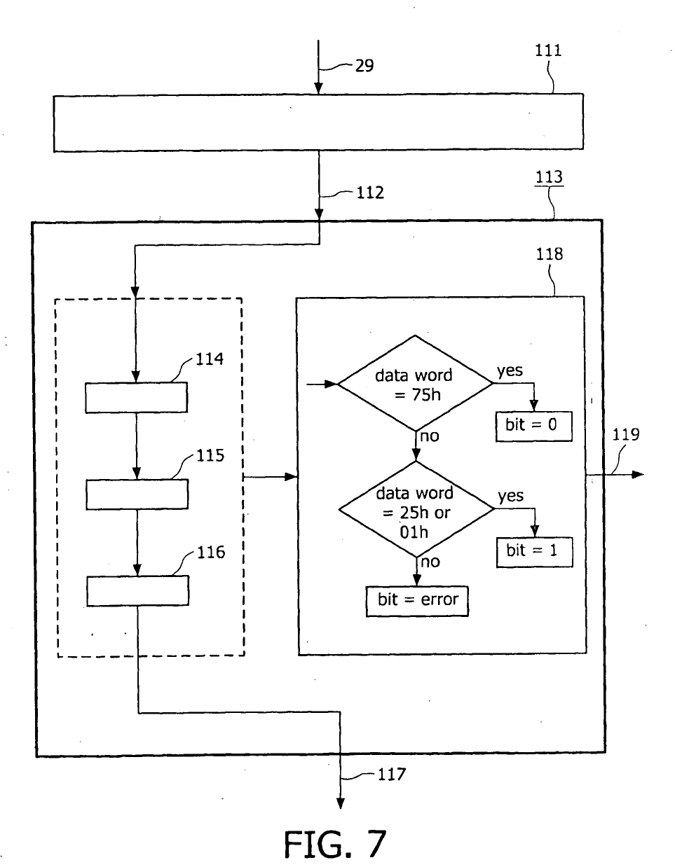

FIG. 7 shows an apparatus for reproducing secondary information.

FIG. 1 illustrates the basic principle of a post-recording process, as for instance known from WO 02/101733. FIG. 1A shows how a land portion 11, located between two pit portions 10 and 12, is modified by the application of a high power laser radiation 13 which, in the known method, causes laser ablation and a reflectivity change so that the reflectivity of the previous land portion 11 is low and comparable to the reflectivity of the neighboring (stamped) pit portions 10 and 12. The sequence pit-land-pit thus results in a long pit area 14.

While in the examples shown in FIG. 1A the whole land area 11 is irradiated by said laser radiation 13, in the example shown in FIG. 1B only part of the land area 11 close to the right-hand pit portion 12 is irradiated by said laser radiation 13 causing only said part of the land portion 11 to be modified into a pit portion. The result is that the edge position 15 of the right-hand pit is modulated, i.e. the run length of said pit has become longer. The pattern which results from this post-recording process can be expressed as the result of the logical operation OR between the pre-existing, or pre-recorded, pattern of pits and lands and a modification mask, which modification mask defines where acts the laser radiation over the pre-existing pattern, where for the pre-existing pattern 1 indicates pit and 0 indicates land, and for the modification mask 1 indicates radiation acting and 0 indicates no radiation acting.

FIG. 2 shows a schematic diagram of a commonly known method for encoding content information, which content information is represented by a sequence of data words 20, the method comprising:
an encoding step 21, comprising a combination of: Error Correction Code (ECC) generation 22, where error code words which allow detection/correction of errors in the data words are added to the sequence of data words, shuffling 23 the sequence of data words, and scrambling 24 the data words, thereby obtaining an encoded sequence of data words 25, and
a modulation step 26, for modulating 27 the encoded sequence of data words 25 into a sequence of channel words 27′, and for associating 28 to the channel words patterns of pits and lands, so as to form the modulated bitstream 29.

A method like this is used according to CD, DVD and also BD standards. The exact sequence and algorithm for ECC generation, shuffling and scrambling varies from standard to standard though, as well as the particular modulation employed.

FIG. 3 shows a schematic diagram of a method of manufacturing a record carrier according to the invention. The encoding step 21 and the modulation steps 26 applied are the same as those shown in FIG. 2. In this case however the method comprises a step of replacing 34 the data words present at predetermined positions in the encoded initial sequence of data words 31 with data words that are converted into desired patterns by the modulation step 26, i.e. the data words corresponding to the desired patterns demodulated. In this way it is obtained a modulation bitstream 33 having the desired patterns at the predetermined positions, which is then used in a subsequent mastering step, not shown in the Figure, thereby obtaining the record carrier.

Thus, the replacing 34 takes place between the encoding step 21 and the modulation step 26. The reason why the replacing 34 takes place before the modulation step 26 has already been explained above and is due to the fact that by doing so it is made sure that no patter is introduced in the modulated bitstream 29 which violates the encoding rules. However it is also advantageous that the replacing 34 takes place after the encoding step 21, for the following reasons:
the order of the data words in the encoded sequence of data words 25 is the same as the order of the channel words in the sequence of channel words 27′, which is the same as the order of the patterns of pits and lands in the modulated bitstream 29, so that the predetermined positions are the same; instead the order of the data words in the sequence of data words 20 is different if the encoding step 21 comprises a shuffling 23,
there is a relatively simple relationship between the data words in the encoded sequence of data words 25 and the channel words in the sequence of channel words 27′; instead the relationship between the data words in the sequence of data words 20 and the channel words in the sequence of channel words 27′ is relatively more complex if the encoding step 21 comprises a scrambling 24.

Any valid patterns can be used in principle as desired patterns (also referred herein as dummy patterns, or patterns for being modified by the post-recording process), a valid pattern being a pattern which may result from the modulation of a data word. However, preferably, the dummy patterns must have the following property: there must be a modification mask such that the result of the logical operation OR between the dummy pattern and the modification mask is also a pattern corresponding to a valid channel word, where the modification mask extends over the pattern to be modified, the modification mask being represented by the value 1 in correspondence to a point to be modified and 0 elsewhere, the dummy pattern being represented by the value 1 in correspondence to a pit and 0 elsewhere. This reflects a modification of the dummy patterns which is effected by laser ablation, whereby pits remain pits and that lands are modified into pits.

It has to be said that due to the modulation used according to optical disc standards it is in general not known a priori with which polarity a given channel word appears in the modulated bitstream 29. Since with the known post-recording method it is only possible to convert ‘lands’ into ‘pits’, it follows that it is necessary to control the polarity of the generated modulated bitstream 29. This need for a control of the polarity in the modulation bitstream can be dispensed with in an embodiment of the method of the invention, according to which regardless of the polarity with which a channel word appears in the modulated bitstream, a modification is applied which modifies the dummy pattern into another pattern corresponding to a valid channel word. That is, the modification mask and the dummy pattern have the further property that the pattern obtainable as the result of the logical operation OR between the negative of the dummy pattern and the modification mask is also a pattern corresponding to a valid channel word. Obviously this restricts the possible choice of dummy patterns and modification masks. In this case it is correct to talk about dummy channel word.

The method according to the invention can be used in conjunction with EFM, EFM+ or 17PP. According to EFM and EFM+, the data words are individually converted into channel words. According to 17PP instead, the conversion of a data word into a channel word (and vice-versa), depend also on the previous and next data word (channel word) in the sequence of encoded data words 25 (sequence of channel words 27′). Therefore, when applying the invention in conjunction with 17PP, preferably the dummy patterns are chosen so as to have the characteristic that during demodulation the dummy patterns as well as the dummy patterns modified are converted into respective data words regardless of the content of the previous and following channel words.

The initial sequence of data words 30 may be for example the content information with appended a sub-sequence of words of irrelevant value, for example all zeroes or random, of an adequate size for storing the secondary information. Then, in the step of replacing 34 only the encoded subsequence is affected, i.e. the data words of irrelevant value are those words, in the encoded initial sequence of data words 31, that can be replaced in the step of replacing 34, without altering the content information.

FIG. 4 shows an embodiment of the method according to the invention. Like in FIG. 3 the initial sequence of data words 30 is encoded in the encoding step 21, thereby obtaining an encoded initial sequence of data words 31, which is modified in a step of replacing 34. In this case however the modified encoded initial sequence of data words 32 id decoded in a decoding step 21′, which performs the inverse operation of the encoding steps 21, thereby obtaining an intermediate sequence of data words 41. This intermediate sequence of data words 41 is then merged with the content information in a merging step 40, thereby obtaining a final sequence of data words 42, which is provided to the usual encoding step 21 and modulation step 26.

The advantage of this approach is that it makes possible to provide the final sequence of data words 42 to a legacy apparatus where usual encoding step 21 and modulation step 26, and possibly mastering step, take place.

In this case the initial sequence of data words 30 may be of an adequate size for storing the secondary information and the content information, and may consist entirely of data words of irrelevant value. The content information may then be inserted in the merging step 40.

In a further alternative the initial sequence of data words 30 may be of an adequate size for storing the content information only, of data words of irrelevant value. The content information may then attached be inserted in the merging step 40.

FIG. 5 shows a schematic diagram of an apparatus for manufacturing a record carrier according to the invention. The apparatus comprises an encoder 50, for performing the encoding step 21, a modulator 51, for performing the modulation step 26, a mastering unit 52 for mastering the record carrier according to the modulated bitstream 33 obtained from the modulation step 26. The apparatus further comprises a control unit 53 comprising in particular a generation unit 54, for providing an initial sequence of data words 30 to the encoder 50, and a replacement unit 55, for replacing 34 the data words present at predetermined position in the encoded initial sequence of data words 31 with data words that are converted into the desired patterns by the modulation step 26, thereby obtaining a modified encoded initial sequence of data words 32, and providing this modified encoded initial sequence of data words 32 to the modulator 51.

FIG. 6 shows a further embodiment of a method for manufacturing a record carrier according to the invention, thought in particular for use in connection to BD standard. An initial sequence of data words 30 is generated in a generation step 60 and encoded in an encoding step 21. The method continues with replacing 34 the data words present at the predetermined positions in the encoded initial sequence of data words 31, passing the modified initial sequence of data words 32 to a decoding step 21′, and merging the intermediate sequence of data words 41 so obtained with the content information in a merging step 40. The final sequence of data words 42 obtained from the merging step 40 is then input to a conventional manufacturing process 61, which yields a plurality of ROM discs 62 having the desired patterns, or dummy patterns, at the predetermined positions and therefore ready for use for post-recording.

Preferably, said predetermined positions do not interfere with the content information, for example by being located in the lead-in, at the beginning of one or more recording frames or ECC frames or after the frame sync of a recording frame (for instance in an application of the invention in a BD system), This makes it easy to detect and decode the post-recorded secondary information.

For the general understanding of the invention, in FIG. 7 it is shown an apparatus for reproducing secondary information from a modulated bitstream 29. The modulated bitstream 29 is received by a demodulation unit 111, where it is converted into a succession of data words 112. This succession of data words 112 is input to a decoding unit 113 which retrieves the content information 117. The decoding unit 113 may include various. units for descrambling 114, deinterleaving 115 and for error correction 116, as these operation are typically involved in storage systems. A checking unit 118 checks the data words present at the positions corresponding to the predetermined positions in the modulated bitstream, where the dummy patterns are located.

Each of these data words is checked against its original value (value associated to the dummy pattern) or the value that may have the dummy pattern when modified by a post-recording process. By establishing if a dummy pattern has been modified or not the secondary information 119 is retrieved. No error correction is applied while retrieving the secondary information, however: if the error correction unit was not disabled, the error correction unit 116 would detect the modifications and correct them to the initial values, thus erasing the effect of the post-recording (if the error level does not exceed the capabilities of the ECC).

The advantage of having both the dummy patterns and the dummy patterns modified as valid patterns is that the demodulation unit 111 can be the same as in a legacy apparatus.

In the Figure it is shown as an example that a data word is checked first against the value 75h (dummy channel word), and if not it is then checked against the value 25h or 01h (dummy channel word modified, according to the polarity), thereby retrieving one bit of information, 0 for dummy channel word not modified or 1 for dummy channel word modified, or vice versa, whichever convention has been made in advance. Briefly summarized, it is essential for an apparatus for reproducing secondary information that it:
identifies the positions in the succession of data words after demodulation, corresponding to the predetermined positions of the dummy patterns in the modulated bitstream, and
checks if the data words contained therein is the one corresponding to the dummy pattern, or to the dummy pattern modified, so as to reconstruct the secondary information.

The invention can be summarized as follows. The present invention relates to a method and to an apparatus for manufacturing a record carrier having stored a content information in the form of a modulated bitstream obtained from the content information by encoding and modulating. The record carrier has a number of dummy patterns at predetermined locations, allowing for the post-recording of secondary information, like an individual code, whereby the secondary information is recorded by selectively modifying the dummy patterns. The method and apparatus according to the invention foresee that the modulated bitstream with dummy patterns at the predetermined positions id obtained by inserting data word corresponding to the dummy patterns in a sequence of data words before the modulation takes place, so as to make sure that the dummy patterns are compliant with the modulation employed.

1. Method of manufacturing a record carrier having stored a content information, represented by a sequence of data words (20), in which record carrier the content information is present in the form of a modulated bitstream (29) obtained from the content information by an encoding/modulating process comprising:
an encoding step (2 1), comprising at least one of:
error code generation (22), for adding to the sequence of data words error code words which allow detection/correction of errors in the data words,
shuffling (23) the sequence of data words, and
scrambling (24) the data words,
thereby obtaining an encoded sequence of data words (25), and
a modulation step (26), for converting (27) the data words into channel words, and for associating (28) patterns of pits and lands to the channel words, so as to form the modulated bitstream (29),
the method of manufacturing comprising:
applying the encoding step to an initial sequence of data words (30), thereby obtaining an encoded initial sequence of data words (31),
replacing (34) the data words present at predetermined position in the encoded initial sequence of data words with data words that are converted into desired patterns by the modulation step, thereby obtaining a modified encoded initial sequence of data words (32),
applying the modulation step to the modified encoded initial sequence of data words, thereby obtaining a modulated bitstream having the desired patterns at the predetermined positions (33), and
mastering the record carrier according to said modulated bitstream.

2. Method as claimed in claim 1, cit after the step of replacing (34):
a decoding step (21′), inverse of the encoding step (21), is applied to the modified encoded initial sequence of data words (32), thereby obtaining an intermediate sequence of data words (41) which is merged in a merging step (40) with the content information so as to obtain a final sequence of data words (42).

3. Method as claimed in claim 2, cit the encoding/modulating process is applied to the final sequence of data words (42).

4. Apparatus for manufacturing a record carrier having stored a content information, represented by a sequence of data words (20), in which record carrier the content information is present in the form of a modulated bitstream (29) obtained from the content information by an encoding/modulating process comprising:
an encoding step (21), comprising at least one of:
error code generation (22), for adding to the sequence of data words error code words which allow detection/correction of errors in the data words,
shuffling (23) the sequence of data words, and
scrambling (24) the data words
thereby obtaining an encoded sequence of data words (25), and
a modulation step (26), for converting (27) the data words into channel words, and for associating (28) patterns of pits and lands to the channel words, so as to form the modulated bitstream (29),
the apparatus comprising:
an encoder (50), for performing the encoding step (21),
a modulator (51), for performing the modulation step (26),
a mastering unit (52) for mastering the record carrier according to the modulated bitstream (29) obtained from the modulation step, and
a control unit (53) for providing an initial sequence of data words (30) to the encoder, thereby obtaining an encoded initial sequence of data words (31), and for replacing (34) the data words present at predetermined positions in the encoded initial sequence of data words with data words that are converted into desired patterns by the modulation step, thereby obtaining a modified encoded initial sequence of data words (32), and providing this encoded initial sequence of data words to the modulator.

5. Apparatus as claimed in claim 4, further comprising a generation unit (54), for generating the initial sequence of data words (30).

6. Apparatus as claimed in claim 4, further comprising a merging unit (55), for merging the intermediate sequence of data words (41) with the content information so as to obtain a final sequence of data words (42).

7. Apparatus as claimed in claim 4, wherein the encoder (50) comprises polarity control means for controlling the polarity of the pattern of pits and lands at the predetermined positions.
